(19) United States
(12) Patent Application Publication
(10) Pub. No.: US 2016/0043536 A1
(43) Pub. Date: Feb. 11, 2016

(54) Pipe Receiving Element

(71) Applicants: Wolfgang RIXEN, Solingen (DE); Gerrit PIES, Solingen (DE)

(72) Inventors: Wolfgang Rixen, Solingen (DE); Gerrit Pies, Solingen (DE)

(21) Appl. No.: 14/386,348

(22) PCT Filed: Mar. 13, 2013
(86) PCT No.: PCT/EP2013/000736

§ 371 Date: Sep. 19, 2014

(30) Foreign Application Priority Data
Mar. 19, 2012 (DE) 20 2012 002 733.6

(51) Int. Cl. H02G 3/04; F16L 3/13; F16L 3/24

(52) U.S. Cl. CPC H02G 3/0437; F16L 3/24; F16L 3/13

(57) ABSTRACT

Pipe receiving element (10) with a base (12), at least two side pieces (14) extending in the same direction from the base (12) and with a cover (20) closing at least the free ends of the side pieces (14) for forming at least one chamber (18) for receiving a pipe (16), characterised in that the base (12) is provided with a fixing device (22) on the side facing away from the cover (20), all components consist of at least one plastic material, and the at least one cover (20) is provided with at least one longitudinal slit (24) running in the longitudinal direction of the chamber (18), as a result of which the cover (20) consists of two moveable lips (26) per chamber (18).

The invention resides in a pipe receiving element comprising a base, at least two lateral parts that extend away from the base in the same direction, and comprising at least one cover that closes off the free ends of the lateral parts for forming at least one chamber for receiving a conduit.

In connection with the working space system of the applicants, there is a need for solutions with regard to simple and visually clean placement of electrical, pneumatic etc. conduits.

Indeed, the applicants already offer various (aluminum) cable channels and also a modular system for cable channels, but these products require detailed planning. This is so because the rigid aluminum channels can be processed only on an appropriate saw that also serves for cutting to length profiled sections for construction.

First, bores must be provided for assembly or complex connecting techniques must be employed. The sawed ends of the profiled sections are stiff and sharp-edged which requires additional components, for example, edge strips or cable passages or the like, for protecting the incoming or outgoing conduits.

This is in conformity with the desires of the customers of the applicant but the precise demand for conduit guiding means usually becomes apparent only upon furnishing the racks, tables or the like. Accordingly, after construction of the basic rack, it is thus necessary to so to speak “post-plan” and tailor and configure the appropriate channels.

This generates together with the high-quality products very high costs which, based on experience, most users will avoid. Based on current knowledge, no solution is known in the general prior art.

The invention has therefore the object to provide a conduit receiving element of the aforementioned kind that, when furnishing racks, tables or the like, enables with simplest technical means an adaptation of the conduit receiving elements on site with very minimal expenditure and, at the same time, reduces significantly the time required for assembly of such constructions.

According to the invention, this object is solved for a conduit receiving element of the aforementioned kind in that the base on the side which is facing away from the cover is provided with a fastening device, all components are made of at least one plastic material, and in that the at least one cover is provided with at least one longitudinal slot extending in the longitudinal direction of the chamber so that the cover is comprised of two movable lips for each chamber.

The gist of the invention resides in fastening the required conduit receiving elements on site in order to enable the preferably electrical, pneumatic or liquid-conducting conduits or the like to be inserted simply by pressing these conduits into the chamber due to the opening capability of the two lips. Also, these conduit receiving elements can be cut to length simply by scissors.

In this way, several points of the object to be solved are solved, here in connection with an aluminum profiled section with undercut grooves as an example:
the conduits are extending invisible in a closed profiled section along the supports of the frame;
the attachment is realized by adhesion or by pressing in a projection into a groove of the aluminum profiled section without further processing;
the conduits can enter or exit at any location of the profiled section without damaging or machining the profiled section so that these modifications of the equipment can be carried out in a simpler and cleaner way;
the ends of the profiled sections, as the lips, can be elastic and therefore the need for additional conduit protection is avoided;
cutting to length of the required members can be realized by a technician during installation on the working site because a saw is no longer required;
processing is chipless and therefore extremely clean;
flat angles can be even bridged by the elasticity of the material without the profiled section having to be cut; and
the conduits are individually guided in separate hollow chambers so that, at any time, they can be individually removed or exchanged; they will therefore not become entangled as within a single channel.

As already indicated above, it is possible that the fastening device is an adhesive layer with which the conduit receiving element can be attached at any location.

When using appropriate profiled sections, it is however particularly advantageous when the fastening device is at least one projection that is arranged on the base and that is extending in opposite direction relative to the lateral parts or webs, wherein its cross-sectional shape, viewed in longitudinal direction, can be brought into engagement with at least one undercut of an undercut groove arranged in a profiled rod.

A particularly strong but also simple type of fastening of the conduit receiving element is already possible very simply for profiled rods with undercut grooves. For this purpose, it is advantageous when the at least one projection on the conduit receiving element, viewed in longitudinal direction, extends such on the base that the conduit receiving element is matched to the outer contour of a profiled rod.

There are also profiled rods of rectangular shape provided with undercut grooves. In this context, it is then possible to provide on the longitudinal side of these profiled sections at least two projections. When this is the case, it is particularly advantageous when at least two projections are arranged on the base.

Moreover, it is particularly advantageous in this context when the base, the webs, the cover, and the projection are monolithically comprised of an elastic material.

For a better adaptation of the elastic properties of the various elements, it is advantageous when the base, the webs, the cover, and the projection are monolithically comprised of different materials wherein the cover material and the projection material are more elastic than the web material.

A particularly good adaptation of the elastic properties of the webs is provided when the webs are embodied of the cover material and the base material without being mixed, but monolithic.

For example, this is possible in that the cover material at the beginning of the web has the greatest thickness which, in the direction toward the base, continuously decreases relative to the thickness of the web.

As a particular protection but also for providing a visually pleasing form, it is advantageous when the cover material will also envelope the exterior surfaces of the two outer webs. Mainly as a function of the pressure to be applied for attaching the conduit receiving elements, it is advantageous when the thickness of the webs deviates from the thickness of the cover and of the base.

In this context, it is possible that the webs have different thicknesses.

In order to provide for an even greater reliability that, after an extended period of use, the lips will return into their original shape, it is advantageous when the connections at the transitions of the lateral parts or webs into the cover either are reinforced with the web material or with the cover material or with a combination of both materials.

Further advantages and features of the invention result from the following description of several embodiments as well as from the figures referenced herein. It is shown in:

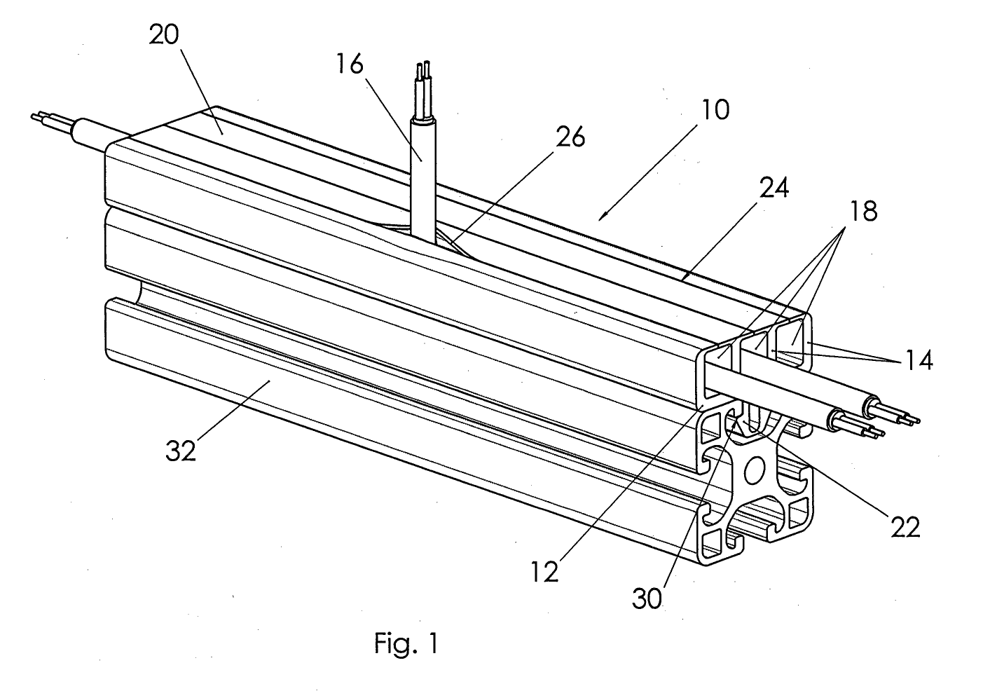

FIG. 1 a perspective illustration of a first embodiment of a conduit receiving element, here in combination with a profiled rod;

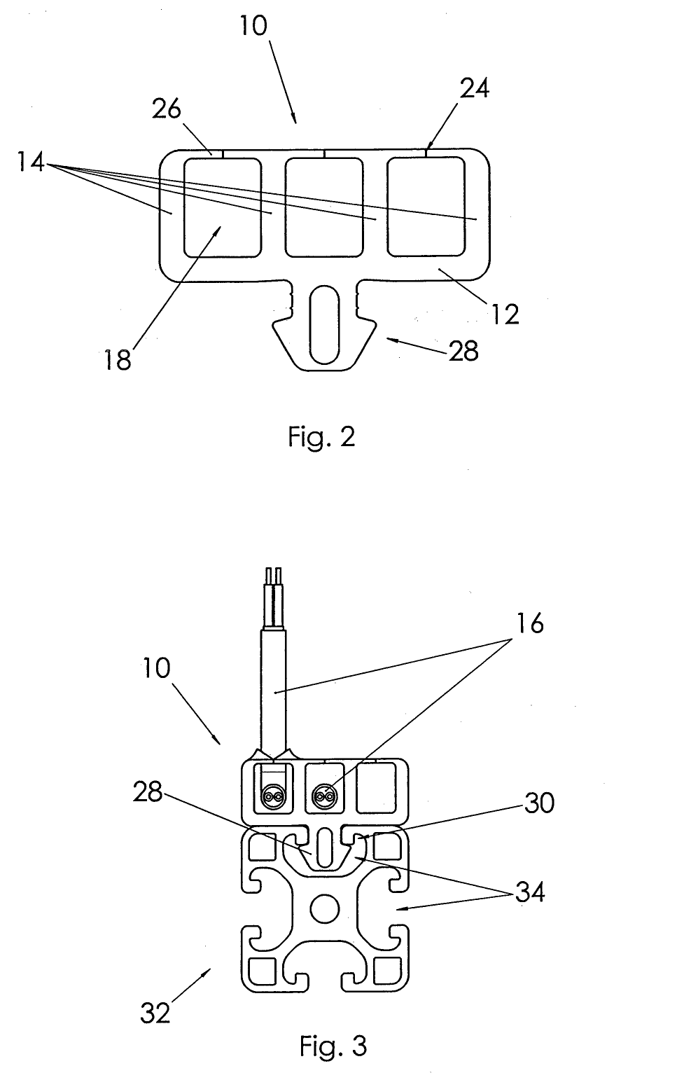

FIG. 2 the cross-section of the receiving element according to FIG. 1;

FIG. 3 the cross-section of the arrangement according to FIG. 1; and

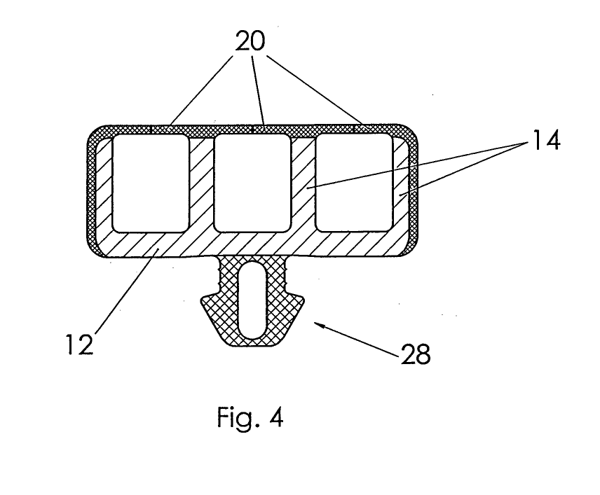

FIG. 4 a further embodiment of a conduit receiving element with different materials

With the aid of FIGS. 1 to 4, two embodiments of a conduit receiving element 10 will be explained in more detail. Same reference characters indicate same features inasmuch as nothing to the contrary is indicated.

The first embodiment, illustrated in FIGS. 1 to 3, comprises a base 12 as does the embodiment according to FIG. 4. In this embodiment, four lateral parts 14 are extending in the same direction away from this base 12 and, in this constellation, form three chambers 18 for receiving a conduit 16, respectively.

The three chambers 18 are closed off at the side which is opposite the base 12 by a so-called cover 20.

The special feature in all embodiments now resides in that this cover 20 is provided approximately at the center of the longitudinal chamber axis with a longitudinal slot 24.

Due to this longitudinal slot 24, the areas of the chambers 14 are provided with movable lips 26. Since the material for the conduit receiving elements 10 is comprised of at least one plastic material, the lips 26 are movable in the direction of the chamber 18 as well as outwardly.

Even though for attachment of the conduit receiving element 10 the base 12 may be provided with an adhesive strip in order to attach this conduit receiving element 10 at a desired location, which location of course must be suitable for adhesive attachment, a different fastening possibility is selected.

The illustrated embodiments comprise this different fastening possibility which in this case are inserted in undercut grooves 34 of a profiled rod 32. This type of connection concerns a projection 28 that as a result of its cross-sectional shape, viewed in the longitudinal direction, locks elastically at the undercut 30 of the undercut groove 34.

As can be seen in FIGS. 1 and 3, after attachment of the conduit receiving elements or conduit receiving element 10, conduits 16, in this case electrical lines, by placement onto a longitudinal slot 24 and a firm pressing action can be pressed in, in the direction of the chamber 18, by displacement of the lips 26.

Also, in the two figures it is shown how at any location a conduit 16 exits again from the chamber 18, namely with formation of an elongate opening of the two lips 26.

In reverse order, the inserted cable 16 can be easily removed and replaced with a new or different kind of cable 16. Based on the cross-section illustrated in FIG. 2, but also based on the cross-section of the second embodiment illustrated in FIG. 4, it is apparent that by variation of the individual wall thicknesses different spring tensions or so-called spring constants are possible, in particular for the lips 26 by variation of the wall thickness.

These variations of different spring forces for restoring the lips 26 into their original position can be even more easily seen in the cross-section of FIG. 4 which shows the second embodiment. Here the base 12 and the webs 14 are made of one plastic material while the material of the cover 20 and of the projection 28 not only relative to each other, but also with regard to the base web complex, are each comprised of a different material.

According to FIG. 4, the thicknesses of the outer webs 14 are less than that of the two inner webs.

In order to achieve again a uniform thickness ratio, viewed in cross-section, in the second embodiment according to FIG. 4, the cover 20 is arranged also on the exterior surfaces of the two outermost webs 14 as an envelope down to the base. This not only serves for protecting the surface of the conduit receiving element 10 but also for providing a uniform visual appearance.

What is possible also, but not shown in the figures, resides in that the cover material. at the beginning of the web 14, has the greatest thickness which decreases continuously in the direction of the base 12 relative to the thickness of the web 14. This has no visual reason but serves for better adjustment of the spring constant of the webs 14 in interaction with the lips 26.

A further possibility, not illustrated, resides also in that the connections or transitions of the lateral parts or webs 14 into the cover 20 are reinforced either with the web material or with the cover material or with a combination of both materials. In this way, the force on the lips 24 at the location where a conduit 16 has passed through for a long period of time is significantly increased. In this context it should be noted that the reinforcements extend into the chambers 18 in order to not disturbed the visual appearance. However, these reinforcements can be arranged also above the webs and outside of the cover 20.

Moreover, it is of course possible to provide more or fewer than the illustrated chambers 18 for the conduit receiving element. The number of projections 28 is not dependent on the number of chambers 18. For large conduit receiving elements 10 several projections 28 may be useful.

### LIST OF REFERENCE CHARACTERS

10 conduit receiving element
12 base
14 lateral part, web
16 conduit
18 chamber
20 cover
22 fastening device
24 longitudinal slot
26 lip
28 projection
30 undercut
32 profiled rod
34 undercut groove

What is claimed is:

1.-14. (canceled)

15. A conduit receiving element comprising:
a base;
at least two lateral parts extending away from the base in a common first direction and having free ends remote from the base;
at least one cover connected to the free ends of the at least two lateral parts, wherein the base, the at least two lateral parts, and the at least one cover define at least one chamber adapted to receive a conduit;
wherein the base comprises a fastening device arranged on a side of the base which is facing away from the at least one cover;
wherein the base, the at least two lateral parts, and the at least one cover are comprised of at least one plastic material;
wherein the least one cover comprises at least one longitudinal slot extending in a longitudinal direction of the at least one chamber so that the at least one cover is comprised of two movable lips covering the at least one chamber.

16. The conduit receiving element according to claim 15, wherein a conduit to be received in the at least one chamber is an electrical, pneumatic, or liquid-conducting conduit.

17. The conduit receiving element according to claim 15, wherein the fastening device is an adhesive layer with which the conduit receiving element is attachable at any location.

18. The conduit receiving element according to claim 15, wherein the fastening device is at least one projection arranged on the base and extending away from the base in a second direction opposite to the first direction, wherein a cross-sectional shape of the at least one projection, viewed in a longitudinal direction of the conduit receiving element, is adapted to engage at least one undercut of at least one undercut groove of a profiled rod to which the conduit receiving element is to be attached

19. The conduit receiving element according to claim 18, wherein, viewed in said longitudinal direction, the at least one projection extends on the conduit receiving element in such a way on the base that the conduit receiving element is matched to an outer contour of a profiled rod.

20. The conduit receiving element according to claim 18, wherein the base comprises at least two of said at least one projection.

21. The conduit receiving element according to claim 18, wherein the base, the at least two lateral parts, the at least one cover, and the at least one projection are comprised monolithically of one plastic material.

22. The conduit receiving element according to claim 18, wherein the base, the at least two lateral parts, the at least one cover, and the at least one projection are comprised monolithically of different materials, wherein the at least one cover is comprised of a cover material and the at least one projection is comprised of a projection material, and wherein the cover material and the projection material are more elastic than a material of which the at least two lateral parts are comprised.

23. The conduit receiving element according to claim 22, wherein the base is comprised of a base material, wherein the at least two lateral parts are formed of the cover material and of the base material, the cover material and the base material being unmixed but monolithic.

24. The conduit receiving element according to claim 23, wherein the cover material is arranged in the at least two lateral parts such that the cover material has a greatest thickness at a location where the at least two lateral parts are connected to the at least one cover, wherein a thickness of the cover material in the at least two lateral parts decreases continuously relative to a thickness of the at least two lateral parts in a direction from said greatest thickness toward the base.

25. The conduit receiving element according to claim 22, wherein the cover material envelopes outer surfaces of the at least two lateral parts.

26. The conduit receiving element according to claim 15, wherein a thickness of the at least two lateral parts deviates from a thickness of the at least one cover and from a thickness of the base.

27. The conduit receiving element according to claim 26, wherein the at least two lateral parts have different thicknesses.

28. The conduit receiving element according to claim 15, wherein a transition from the at least two lateral parts into the at least one cover is reinforced with a material of which the at least two lateral parts are comprised.

29. The conduit receiving element according to claim 15, wherein a transition from the at least two lateral parts into the at least one cover is reinforced with a material of which the at least one cover is comprised.

30. The conduit receiving element according to claim 15, wherein a transition from the at least two lateral parts into the at least one cover is reinforced with a first material of which the at least two lateral parts are comprised and with a second material of which the at least one cover is comprised.
